(19) United States
(12) Patent Application Publication
(10) Pub. No.: US 2026/0043393 A1
(43) Pub. Date: Feb. 12, 2026

(54) Axial Piston Machine in Slanted Axis Design with Pre-Compression Volume

(71) Applicant: Robert Bosch GmbH, Stuttgart (DE)

(72) Inventors: Alexander Bidell, Waldstetten (DE); Andreas Utler, Krumbach (DE); Marcus Herrmann, Elchingen (DE); Thomas Abenstein, Buch (DE)

(21) Appl. No.: 19/290,816

(22) Filed: Aug. 5, 2025

(30) Foreign Application Priority Data
Aug. 9, 2024 (DE) 10 2024 207 593.0

(51) Int. Cl. F04B 1/24; F04B 1/2064

(52) U.S. Cl. CPC F04B 1/24; F04B 1/2064

(57) ABSTRACT

An axial piston machine in a slanted axis design with constant displacement volume is disclosed. A tapping opening is arranged in the first reversing region, which can be brought into fluid exchange connection with one of the openings in each case by rotating the cylinder drum. The tapping opening is permanently connected to a pre-compression chamber via a connection channel, which runs completely in the housing. The pre-compression chamber is formed closed with the exception of the connection channel, wherein it is arranged completely in the housing.

This application claims priority under 35 U.S.C. § 119 to application no. DE 10 2024 207 593.0, filed on Aug. 9, 2024 in Germany, the disclosure of which is incorporated herein by reference in its entirety.

The disclosure relates to an axial piston machine.

### BACKGROUND

An axial piston machine in a slanted axis design which has a constant displacement volume is known from DE 10 2019 202 483 A1. This is typically operated as an engine, wherein, for example, a vehicle wheel or cable drum is driven directly by the axial piston machine. The speeds occurring in operation are subsequently low. The housing comprises a first and a second housing portion, each of which has a one-piece and pot-like design.

A further axial piston machine in a slanted axis design with a constant displacement volume is known from U.S. Pat. No. 4,382,399 A. The housing comprises a tubular housing portion, which is closed at each of its two opposite ends with a plate-like cover.

An axial piston machine in a swashplate design, which is equipped with an externally-built pre-compression volume is known from DE 10 2022 202 520 A1. Swashplate machines are often operated as a pump, using high speeds to achieve high flows with a small machine. As the speed increases, pressure pulsations increase. As a result, noise formation and vibration occur. This effect can be countered with a pre-compression volume.

The object of the disclosure is to provide an axial piston machine in slanted axis design with constant displacement volume, which is to be operated primarily as a pump. The axial piston machine is intended to be driven by a variable speed electric motor to allow for displacement of the flow rate. The axial piston machine is designed to operate quietly even at high drive speeds. The axial piston machine should be compact and cost-effective to manufacture. The axial piston machine is intended to be self-priming even at a high speed or high flow.

### SUMMARY

According to the disclosure, it is proposed that a tapping opening is arranged in the first reversing region, which can be brought into fluid exchange connection with one of the openings in each case by rotating the cylinder drum, wherein the tapping opening is permanently connected to a pre-compression chamber via a connecting channel, which runs completely in the housing, wherein the pre-compression chamber is formed closed with the exception of the connecting channel, wherein it is arranged completely in the housing.

The first and second axis of rotation preferably intersect, wherein they may intersect with a small distance. The control surface and the counter-control surface are preferably spherical, wherein the counter-control surface is most preferably concave, wherein the control surface is convex. The working pistons are preferably linearly movable parallel to the second axis of rotation, wherein the direction of movement can also be slightly, in particular less than 15°, inclined towards the second axis of rotation. The aforementioned angle of inclination is preferably between 20° and 30°, in particular 25°. It is contemplated that the aforementioned angle of inclination is about 40° when the axial piston machine is used as an engine, as is customary. Preferably, nine working pistons are provided. The axial piston machine is preferably operated with a pressurized fluid, most preferably a hydraulic fluid, and in particular with hydraulic oil.

Advantageous developments and improvements of the disclosure are specified below.

It may be contemplated that the pre-compression chamber extends with a constant cross-sectional shape along an axis of extension, wherein the axis of extension is arranged at most 15° inclined towards the second axis of rotation, wherein the pre-compression chamber is arranged transversely to the second axis of rotation adjacent to the cylinder drum. The main dimensions of the axial piston machine according to the disclosure thus substantially do not increase compared to the known axial piston machine. The axis of extension and the second axis of rotation are preferably parallel to each other. The aforementioned cross-sectional shape is preferably formed as a circular. In the direction of the second axis of rotation, the pre-compression chamber preferably extends beyond the cylinder drum, most preferably on both opposite sides of the cylinder drum.

It may be contemplated that the housing comprises a first and a second housing portion, which are each pot-like and formed in one-piece, wherein they abut one another with their open sides, enclosing an interior, wherein the drive shaft, the cylinder drum and the working pistons are arranged in the interior, wherein the drive shaft is rotatably mounted on the first housing portion only, wherein the pre-compression chamber is arranged away from the first housing portion, wherein it is limited at least in sections by the second housing portion. In particular, the second housing portion with the pre-compression chamber can be designed to save material and can also be easily manufactured. The first and the second working connection are preferably arranged on the second housing portion.

It may be contemplated that the pot-like and second housing portion in a one-piece design comprises an annular portion and a bottom portion, wherein the pre-compression chamber is arranged in the annular portion with at least 50% of its volume. Particularly little material is thus required for the second housing portion, although it is nevertheless very stiff. The first and second working connection are preferably arranged on the bottom portion.

It may be provided that the pre-compression chamber is configured as a bore directly in the second housing portion, wherein the aforementioned bore is closed with a first closing screw, wherein the first closing screw is screwed into the second housing portion in the area of the bottom portion. The aforementioned bore is easily manufactured, wherein it can in particular be drilled together with the first and the second working connections in a clamping operation. The aforementioned bore is preferably designed to be open on one side.

It may be contemplated that the second axis of rotation and the extension axis span a central plane, wherein the first and second control kidneys are each arranged completely on opposite sides of the central plane, such that the central plane intersects the first and the second reversing regions. These features are used in particular to determine the position of the pre-compression chamber on the circumference of the second housing portion. The proposed arrangement results in a particularly compact axial piston machine.

It may be contemplated that the first reversing region is arranged with the tapping opening and the pre-compression chamber on the same side of the second axis of rotation. A particularly high pressure in the pressure field between the control surface and the counter-control surface acts at the location of the tapping opening. With the proposed arrangement, the corresponding pressure acts approximately centrally on the sealing surface between the first and second housing portions, so that there is no risk of the sealing contact gaping apart on one side.

It may be provided that the control surface is arranged on a separate control plate, which is fixedly arranged on the remaining housing, wherein a first portion of the connection channel intersects the control plate parallel to the second axis of rotation. The separate control plate preferably consists of a non-ferrous metal, in particular brass or bronze, in order to minimize wear.

It may be provided that the connection channel is arranged exclusively and directly in the second housing portion away from the control plate. The second and the third sections of the connection channel can thus be provided inexpensively and in a space-saving manner.

It may be provided that the connection channel in the second housing portion comprises a second and a third portion, which each run straight, wherein they are directly adjacent to one another, wherein the second section extends from the control plate parallel to the second axis of rotation, wherein the third portion extends transversely to the second axis of rotation as far as the pre-compression chamber. The second and the third sections of the connection channel can thus be manufactured simply and inexpensively as straight bores. The aforementioned third portion is preferably perpendicular to the second axis of rotation. The third section preferably opens out at an inner circumferential surface of the pre-compression chamber.

It may be provided that the first, the second and the third sections of the connection channel are arranged parallel to the central plane. Depending on the desired location of the tapping opening within the first reversing area, the central plane intersects the connection channel, which may also be arranged at a distance from the connection channel.

It may be provided that the first and the second housing portions are screwed together with an odd number of connection screws, wherein the connection screws are arranged in a mirror-symmetrical manner with respect to the central plane, wherein one of the connection screws is arranged in the area of the central plane, namely on the side of the second axis of rotation facing away from the pre-compression chamber. Without the center connecting screw, it is to be feared that the sealing gap between the first and second housing portion will gape apart minimally due to the hydraulic forces in the axial piston machine. This can result in increased structure-borne noise emissions. This can be avoided by the center connecting screw.

Of course, the above-mentioned features and those to be explained below can be used not only in the combination indicated in each case, but also in other combinations or on their own, without going beyond the scope of the present disclosure.

### BRIEF DESCRIPTION OF THE DRAWINGS

The disclosure is explained in more detail below with reference to the enclosed drawings. The figure shows:

FIG. 1 a perspective view of an axial piston machine according to the disclosure;

FIG. 2 a longitudinal section of the axial piston machine of FIG. 1; and

FIG. 3 a perspective view of the control plate of the axial piston machine of FIG. 1.

### DETAILED DESCRIPTION

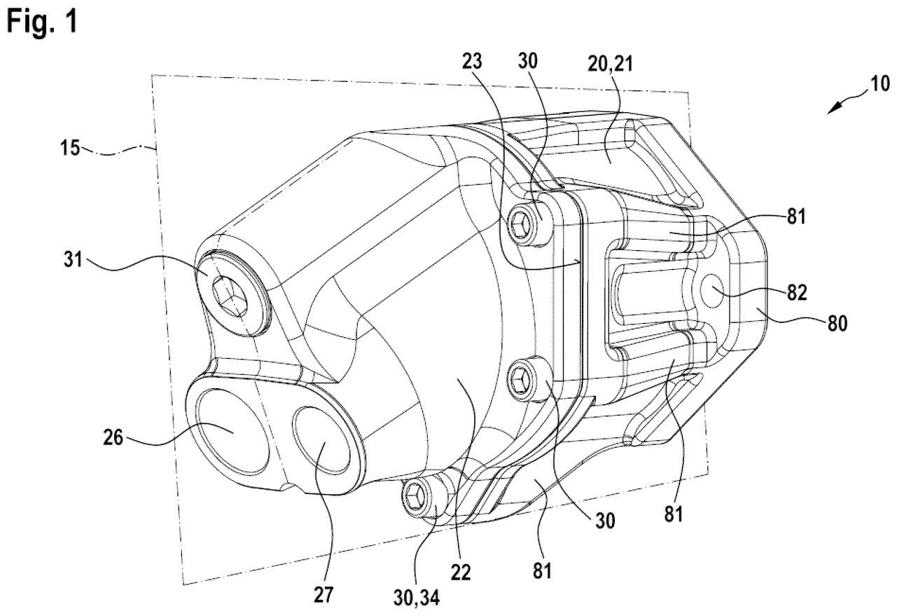

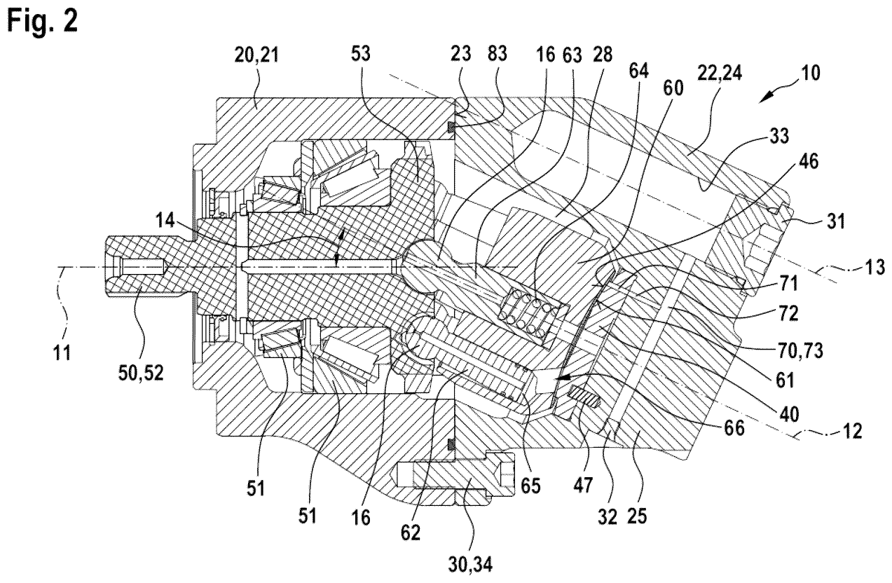

FIG. 1 shows a perspective view of an axial piston machine 10 according to the disclosure. The axial piston machine 10 comprises a housing 20 that defines a central plane 15. The housing 20 comprises a first and a second housing portion 21; 22, each of which has a pot-like and one-piece design, with their open side lying tightly against each, so that they enclose a closed interior (no. 28 in FIG. 2). The corresponding sealing surface 23 is planar and is aligned perpendicular to the first axis of rotation (no. 11 in FIG. 2).

A first and a second working connection 26; 27 are provided on the second housing portion 22, which are in the present case arranged on the front side of the housing 20. The first and/or second working connection 26; 27 may also be arranged laterally on the housing 20, although mixing shapes are also contemplated. The first working connection 26 has a larger diameter than the second working connection 27. Accordingly, in pumping operation, the first working connection 26 is preferably used as a suction port, with the second working connection 27 being the pressure connection.

In the present case, the first and the second housing portions 21; 22 are bolted together via five connecting screws 30, which are arranged in a mirror-symmetric manner with respect to the central plane 15. Accordingly, a center connecting screw 34 is arranged in the area of the central plane 15.

The first housing portion 21 includes a fastening flange 80. The fastening flange 80 may be configured according to a desired, standardized variant. In the present case, a variant was selected comprising two fastening breakthroughs 82 arranged in a mirror symmetrical manner to the central plane 15, wherein they pass through the fastening flange 80 parallel to the first axis of rotation (no. 11 in FIG. 2).

The connection screws 30 are each screwed into an associated rib 81 of the first housing portion 21, each of which extends as far as the fastening flange 80. This results in a high stiffness of the housing 20.

It should also be noted that the first closing screw 31 in the second housing portion 22 is used to close the front of the pre-compression chamber (no. 33 in FIG. 2).

FIG. 2 shows a longitudinal section of the axial piston machine 10 of FIG. 1. In the pot-like first housing portion 21, a drive shaft 50 is rotatably mounted with respect to a first axis of rotation 11. The two corresponding rotary bearings 51 are designed as roller bearings, in particular tapered roller bearings. The drive shaft 50 projects out of the housing 20 with a drive pin 52 so that, for example, it can be brought into rotational drive connection with an electric motor (not shown). On the side of the pivot bearings 51 facing away from the drive pin 52, the drive shaft 50 is provided with a flange 53. There, the working pistons 62 are each motion-coupled to the drive shaft 50 via an associated ball joint 16. The ball joints 16 of the working pistons 62 are arranged at a constant radius spaced apart from the first and second axis of rotation 11; 12. A further ball joint 16 is arranged exactly at the intersection of the first and second axis of rotation 11; 12. This ball joint 16 is associated with a guide piston 63, the center axis of which coincides with the second axis of rotation 12.

The cylinder drum 60 is rotatable relative to the second axis of rotation 12. The working pistons 62 are received in the cylinder drum 60 so that they can move linearly in the direction of the second axis of rotation 12, such that they each delimit a working area 65 with the cylinder drum 60. Its volume changes when the cylinder drum 60 rotates about the second axis of rotation 12 because the angle of inclination 14 between the first and the second axis of rotation 11; 12 is different from zero, in the present case being 25°. In the present case, nine working pistons 62 are provided.

In the present case, the aforementioned angle of inclination 14 is fixed, in that the separate control plate 40 is fixedly received in the second housing portion 22. The control plate 40 is considered a component of the housing 20 in the context of the present application. It forms the control surface 46, which can also be arranged directly on the second housing portion 22. To minimize wear, a separate control plate 40 made of a non-ferrous metal, in particular brass or bronze, is provided, wherein the first and/or the second housing part 21; 22 are made of cast iron or aluminum. The control plate 40 is received in an adapted circular cylindrical recess in the second housing portion 22 with respect to the second axis of rotation 12. An anti-rotation device 47 of the control plate 40 is effected by way of a cylindrical pin that engages with adapted bores in the control plate 40 and in the second housing portion 22.

The control surface 46 is non-planar, being arranged rotationally symmetrically relative to the second axis of rotation 12. The cylinder drum 60 slidably abuts the control surface 46 with an adapted counter-control surface 61, wherein the position of the second axis of rotation 12 is already defined by this engagement. The guide piston 63 and the spring 64 there ensure that the cylinder drum 60 is arranged concentrically to the second axis of rotation 12, even when depressurized. The control surface 46 and the counter-control surface 61 are preferably spherical, wherein the control surface 46 is most preferably convexly curved, wherein the counter-control surface 61 is concavely curved. Each working area 65 opens out at the counter-control surface 61 with an associated opening 66.

The second housing portion 22 comprises an annular portion 24 and a bottom portion 25. The pre-compression chamber 33 is formed from an open bore on one side, which extends with a constant, in the present case circular, cross-sectional shape along an axis of extension 13. It is contemplated that the pre-compression chamber 33 may be formed by a cast core when casting the second housing portion. In this respect, it may be necessary to hold the aforementioned casting core at both opposite ends in the direction of the axis of extension 13, so that a further closing screw (not shown) is required for a retaining breakthrough (not shown) in the second housing portion 22. In the present case, the axis of extension 13 is arranged parallel to the second axis of rotation 12, wherein it can also be slightly inclined towards the second axis of rotation 12. The pre-compression chamber 33 extends towards the axis of extension 13 beyond the cylinder drum 60, at both ends of the cylinder drum 60, to achieve a large volume of the pre-compression chamber 33. Accordingly, at least 50% of its volume is arranged in the annular portion 24 of the second housing portion 22, wherein the remainder of the pre-compression chamber 33 is arranged in the bottom portion 25. There, the one-sided opening of the pre-compression chamber 33 is also arranged, which is sealed in a fluid-tight manner with a separate first closing screw 31.

The second axis of rotation 12 is inclined away from the pre-compression chamber 33 opposite the first axis of rotation 11. The central connecting screw 34 and the pre-compression chamber 33 are arranged on opposite sides of the second axis of rotation 12.

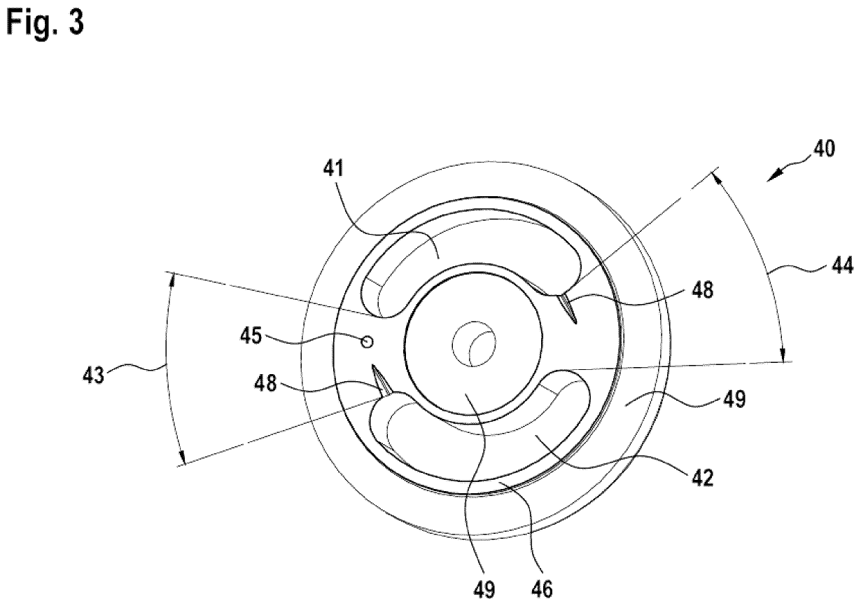

The connection channel 70 from the control surface 46 to the pre-compression chamber 33 comprises a first, a second, and a third portion 71; 72; 73. The first portion 71 intersects the control plate 40 parallel to the second axis of rotation 12, defining the tapping opening (no. 45 in FIG. 3). The second portion 72 extends directly in the second housing portion 22, continuing the first portion 71 in alignment and parallel to the second axis of rotation 12. The third portion 73 runs in a straight line transverse to the second axis of rotation 12, particularly perpendicular to the second axis of rotation 12. The third portion 73 opens directly into the pre-compression chamber 33 such that there is a permanent fluid exchange connection between the tapping opening (no. 45 in FIG. 3) and the pre-compression chamber 33. The third section 73 is preferably drilled from the outside into the second housing portion 22, wherein the corresponding opening is sealed in a fluid-tight manner with a second closing screw 32. The entire connection channel 70 is preferably arranged parallel to the central plane (no. 15 in FIG. 1), in the present case being arranged mirror symmetrically to the central plane (no. 15 in FIG. 1). The central plane is the plane containing the first and the second axis of rotation 11; 12 and the axis of extension 33, namely the drawing plane of FIG. 2. Depending on the desired location of the tapping opening (no. 45 in FIG. 3), the connection channel 70 can also be arranged at a small distance from the central plane.

In FIG. 2, the planar sealing surface 23 can be seen on which the first and the second housing portions 21; 22 fit tightly together, wherein a sealing ring 83 is arranged there. In the present case, the sealing surface 23 is aligned perpendicular to the first axis of rotation 11.

FIG. 3 shows a perspective view of the control plate 40 of the axial piston machine of FIG. 1. The control plate 40 forms a spherical control surface 46, which is convexly domed, wherein the corresponding ball center point lies on the second axis of rotation (no. 12 in FIG. 2). Radially inwards and radially outwards, the control surface 46 is bounded by a recess 49, wherein in each case there is a border line that is rotationally symmetrical to the second axis of rotation (no. 12 in FIG. 2). The first and second control kidneys 41; 42 are arranged within the control surface 46 and each pass through the control plate 40 in the direction of the second axis of rotation (no. 12 in FIG. 2). They are each designed as a curved slot with a constant width, wherein they define a common diameter that is equal to the diameter on which the orifices (no. 66 in FIG. 2) run. When the cylinder drum 60 rotates, each opening comes into fluid exchange alternately with first and second control kidney 41; 42. In the circumferential direction, the first and second control kidneys 41; 42 are spaced apart from each other via a first and a second reversing region 43; 44, each of which is so wide in the circumferential direction that an opening in any position of the cylinder drum cannot cause a low-resistance hydraulic short circuit between the first and second control kidneys 41; 42.

In the first reversing region 43, the tapping opening 45 is arranged, which is formed by the first portion (no. 71 in FIG. 1) of the connection channel. Its exact position and diameter are preferably optimized by testing so that the axial piston machine can be operated at as high a speed as possible without excessive pressure pulsations occurring. The ratios shown in FIG. 3 are to be understood as a first design that is not yet optimized.

Reference is still made to the two notches 48, each of which is associated with a first and second control kidney 41; 42. This may further minimize said pressure pulsation. The present axial piston machine is provided for a fixed direction of rotation, and so the two notches 48 shown are sufficient. Four notches are preferred with a changing direction of rotation.

### REFERENCE SIGNS

10 Axial piston machine
11 First axis of rotation
12 Second axis of rotation
13 Axis of extension
14 Angle of inclination
15 Central plane
16 Ball joint
20 Housing
21 First housing portion
22 Second housing portion
23 Sealing surface
24 Annular portion
25 Bottom portion
26 First working connection
27 Second working connection
28 Interior
30 Connecting screw
31 First closing screw
32 Second closing screw
33 Pre-compression chamber
34 Center connecting screw
40 Control plate
41 First control kidney
42 Second control kidney
43 First reversing region
44 Second reversing region
45 Tapping opening
46 Control surface
47 Anti-rotation device
48 Notch
49 Recess
50 Drive shaft
51 Rotary bearing
52 Drive pin
53 Flange
60 Cylinder drum
61 Counter-control surface
62 Working piston
63 Guide piston
64 Spring
65 Working chamber
66 Opening
70 Connection channel
71 First portion
72 Second portion
73 Third portion
80 Fastening flange
81 Rib
82 Fastening breakthrough
83 Scaling ring

What is claimed is:

1. An axial piston machine, comprising:
a housing, wherein an adapted control surface is fixedly arranged on the housing;
a drive shaft rotatably mounted in the housing with respect to a first axis of rotation;
a cylinder drum having a counter-control surface that slidably abuts the adapted control surface, wherein the adapted control surface is non-planar and rotationally symmetrical with respect to a second axis of rotation, and wherein the first and second axis of rotation are arranged inclined relative to each other at a fixed angle of inclination other than zero;
a plurality of working pistons received in the cylinder drum in a linearly movable manner such that together with the cylinder drum they each limit a working area, wherein the working pistons are each motion-coupled to the drive shaft via a ball joint arranged at distance to the first and the second axis of rotation; and
a first and a second working connection arranged on the housing, which are each permanently fluidically connected to an associated first or second control kidney on the adapted control surface,
wherein each working area opens with an opening on the counter-control surface, and wherein said openings are each configured to be brought into fluid exchange connection with the first or the second control kidney by rotating the cylinder drum, and further wherein the first and second control kidneys are spaced apart from one another in the circumferential direction with respect to the second axis of rotation via a first and a second reversing region, and
wherein a tapping opening is arranged in the first reversing region which is configured to be brought into fluid exchange connection with one of the openings in each case by rotating the cylinder drum, and wherein the tapping opening is permanently connected to a pre-compression chamber via a connection channel which runs completely in the housing, and wherein the pre-compression chamber is formed closed with the exception of the connection channel, and wherein it is arranged completely in the housing.

2. The axial piston machine according to claim 1, wherein:
the pre-compression chamber extends with a constant cross-sectional shape along an axis of extension,
the axis of extension is arranged at most 15° inclined towards the second axis of rotation, and
the pre-compression chamber is arranged transversely to the second axis of rotation adjacent to the cylinder drum.

3. The axial piston machine according to claim 1, wherein:
the housing comprises a first and a second housing portion which are each pot-like and formed in one-piece,
the first and the second housing portion abut one another with their open sides so as to enclose an interior,
the drive shaft, the cylinder drum and the working pistons are arranged in the interior,
the drive shaft is rotatably mounted on the first housing portion only,
the pre-compression chamber is arranged away from the first housing portion, and
the pre-compression chamber is limited at least in sections by the second housing portion.

4. The axial piston machine according to claim 3, wherein:
the pot-like second housing portion is designed in one-piece and comprises an annular portion and a bottom portion, and
the pre-compression chamber is arranged with at least 50% of its volume in the annular portion.

5. The axial piston machine according to claim 4, wherein:
the pre-compression chamber is configured as a bore directly in the second housing portion,
the bore is closed with a first closing screw, and
the first closing screw is screwed into the second housing portion in the area of the bottom portion.

6. The axial piston machine according to claim 2, wherein:
the second axis of rotation and the extension axis span a central plane, and
the first and second control kidneys are each arranged completely on opposite sides of the central plane such that the central plane intersects the first and the second reversing regions.

7. The axial piston machine according to claim 6, wherein:
the first reversing region is arranged with the tapping opening and the pre-compression chamber on the same side of the second axis of rotation.

8. The axial piston machine according to claim 1, wherein:
the control surface is arranged on a separate control plate which is fixedly arranged on the remaining housing, and
a first portion of the connection channel intersects the control plate parallel to the second axis of rotation.

9. The axial piston machine according to claim 8, wherein:
the housing comprises a first and a second housing portion which are each pot-like and formed in one-piece,
the first and the second housing portion abut one another with their open sides so as to enclose an interior,
the drive shaft, the cylinder drum and the working pistons are arranged in the interior,
the drive shaft is rotatably mounted on the first housing portion only,
the pre-compression chamber is arranged away from the first housing portion,
the pre-compression chamber is limited at least in sections by the second housing portion, and
the connection channel is arranged exclusively and directly in the second housing portion away from the control plate.

10. The axial piston machine according to claim 9, wherein:
the connection channel in the second housing portion comprises a second and a third portion which each run straight,
the second and the third portion are directly adjacent to one another,
the second portion extends from the control plate parallel to the second axis of rotation, and
the third portion extends transversely to the second axis of rotation as far as the pre-compression chamber.

11. The axial piston machine according to claim 10, wherein:
the pre-compression chamber extends with a constant cross-sectional shape along an axis of extension,
the axis of extension is arranged at most 15° inclined towards the second axis of rotation,
the pre-compression chamber is arranged transversely to the second axis of rotation adjacent to the cylinder drum,
the second axis of rotation and the extension axis span a central plane,
the first and second control kidneys are each arranged completely on opposite sides of the central plane such that the central plane intersects the first and the second reversing regions, and
the first, the second and the third portions of the connection channel are arranged parallel to the central plane.

12. The axial piston machine according to claim 6, wherein:
the first and the second housing portions are screwed together with an odd number of connection screws,
the connection screws are arranged in a mirror-symmetrical manner with respect to the center plane, and
one of the connection screws is arranged in the area of the central plane on the side of the second axis of rotation facing away from the pre-compression chamber.
